(19) United States
(12) Patent Application Publication
(10) Pub. No.: US 2016/0009429 A1
(43) Pub. Date: Jan. 14, 2016

(54) Method of Creating a Labeled Packaged Product

(71) Applicants: Sean Montgomery Mahoney, Auburn, MA (US); Ryan McCleary, Farwell, MN (US)

(72) Inventors: Sean Montgomery Mahoney, Auburn, MA (US); Ryan McCleary, Farwell, MN (US)

(21) Appl. No.: 14/795,503

(22) Filed: Jul. 9, 2015

Related U.S. Application Data
(60) Provisional application No. 62/022,287, filed on Jul. 9, 2014.

(51) Int. Cl. B65B 29/02; B65C 1/02; B65D 43/02; B65D 25/20; B65D 85/00

(52) U.S. Cl. CPC B65B 29/02; B65D 25/205; B65D 85/70; B65D 43/0233; B65C 1/02

(57) ABSTRACT

A method of printing a cover separate from a sealed consumable product and assembling of the same into a custom labeled consumable product includes imprinting, cutting or embossing a substrate with indicia, creating a cover from the substrate including at least a portion of the indicia and securing the cover to the lid of the sealed consumable product.

### CROSS-REFERENCE TO RELATED APPLICATIONS

This application claims the benefit of priority to U.S. Provisional Patent Application No. 62/022,287, filed Jul. 9, 2014 and entitled “Method of Creating a Labeled Packaged Product,” the entire contents of the application being incorporated herein by reference in its entirety.

### TECHNICAL FIELD

This invention relates to a method of printing and labeling pre-packaged consumer products and more particularly, to a method for creating printable covers for disposable single-serve consumer food and/or beverage containers.

### BACKGROUND

Pre-packaged consumer products, such as single-serve consumer food and beverage containers, have gained popularity because of their convenience for consumers. Such containers may include things such as yogurt, single-brewing beverage cups and cereal bowls, to name but a few. The preparation of a beverage, for example coffee, by using a single-serving beverage filter-cartridge is well known in the art. One popular non-limiting example is the well-known K-Cup® cartridges that are used in Keurig Green Mountain, Inc. coffee brewing systems. Many brands and food manufacturers now have their own single-serving beverage filter-cartridge systems. An exemplary, prior-art cup used in such systems is shown in FIG. 1.

Cup 10 includes an open-top with a peripheral top rim or lip 12 that defines the top opening 14. The top opening is sealed by securing the lid 16, for example by heat-sealing, to the top rim 12. The lid 16 may be cut or blanked from any suitable heat sealable and in some cases piercable material, which may include an oxygen resistant barrier in combination with a material capable of being sealed to the container base. For example, the lid 16 may include a first layer 18 that may comprise a metal foil, such as aluminum foil, which is connected via adhesive lamination to a heat sealable polyethylene layer 20. Such a structure provides a printable upper surface 24 for imprinting the contents and/or branding and which, when sealed, creates a product that is shelf stable for extended periods of time because it limits the amount of oxygen, and thus can be inventoried. Printing the upper surface 24 with the contents and/or brand name and sealing the cup with a lid that has been printed, and that can remain on a shelf for an extended period of time, is well-known as it allows large quantities of cups to be filled, sealed and stored until they are ready for shipment.

In general, most coffee is brewed at temperatures somewhere between 190-200 degrees Fahrenheit. Keurig® brewers come preset at 192 degrees F., with some other single-use machines allowing the user to set the temperature higher. During brewing, using a single-serving cup brewer such the Keurig® brewer as an example, the brewer punctures the foil/plastic sealed lid with a spray nozzle and the bottom of the cup with a discharge nozzle. The spray nozzle forces hot water under pressure through cup and the filter, then through the discharge nozzle and into a user's cup. As will be appreciated, in order that the coffee or other beverage remain fresh the seal must be maintained. Likewise, in order for the lid to be punctured it must also be properly adhered to the cup.

### SUMMARY

While acceptable for large runs of pre-packaged products, such as the afore mentioned single-serving consumer cups, there is a need to have short-run and custom labeled pre-packaged consumable containers, for example single-serve coffee cups, as well as other pre-packaged goods. Compared with large-order and bulk consumables, short-runs of single-serving containers have previously been highly cost-prohibitive and a barrier to entry for smaller companies to compete with larger firms. As product packaging becomes more centralized, branding and labeling of consumable, pre-packaged products may or may not take place in the same location as the packaging of the product, and presents the need for flexibility.

In order to allow for short-run, on-demand printing of pre-packaged consumable containers, the present invention provides a method of printing a cover separate from the sealed consumable product and assembling of the same into a custom, short-run pre-packaged and custom labeled consumable product.

### BRIEF DESCRIPTION OF THE DRAWINGS

Various aspects of at least one embodiment are discussed below with reference to the accompanying figures, which are not necessarily drawn to scale, emphasis instead being placed upon illustrating the principles disclosed herein. The figures are included to provide an illustration and a further understanding of the various aspects and embodiments, and are incorporated in and constitute a part of this specification, but are not intended as a definition of the limits of any particular embodiment. The figures, together with the remainder of the specification, serve to explain principles and operations of the described and claimed aspects and embodiments. In the figures, each identical or nearly identical component that is illustrated in various figures is represented by a like numeral. For purposes of clarity, not every component may be labeled in every figure.

FIG. 1 is an exploded perspective view of a prior art single-serve beverage cup;

FIG. 2 is a perspective view of the prior art single-serve beverage cup of FIG. 1 sealed;

FIG. 3 is a perspective view of an exemplary embodiment of a sealed container and printable substrate according to the present disclosure; and

FIG. 4 is a perspective view of a second exemplary embodiment of a cover for attaching to a printable substrate according to the present disclosure.

### DETAILED DESCRIPTION OF THE ILLUSTRATIVE EMBODIMENTS

The phraseology and terminology used herein is for the purpose of description and should not be regarded as limiting. Any references to examples, embodiments, components, elements or devices described herein referred to in the singular may also embrace embodiments including a plurality, and any references in plural to any embodiment, component, element or device herein may also embrace embodiments including only a singularity. References in the singular or plural form are not intended to limit the presently disclosed device, its components, structure, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

In addition, as used herein the term “foodstuffs” is intended to be non-limiting and includes both food and beverages, and any example describing a beverage or food is to be construed to include either a beverage or a food product or a base used to make a beverage or food product. As also used herein, the terms “container, cup, or cartridge” refers to device for holding a foodstuffs and which is capable of being sealed shut, and is not limited to the particular articles disclosed herein.

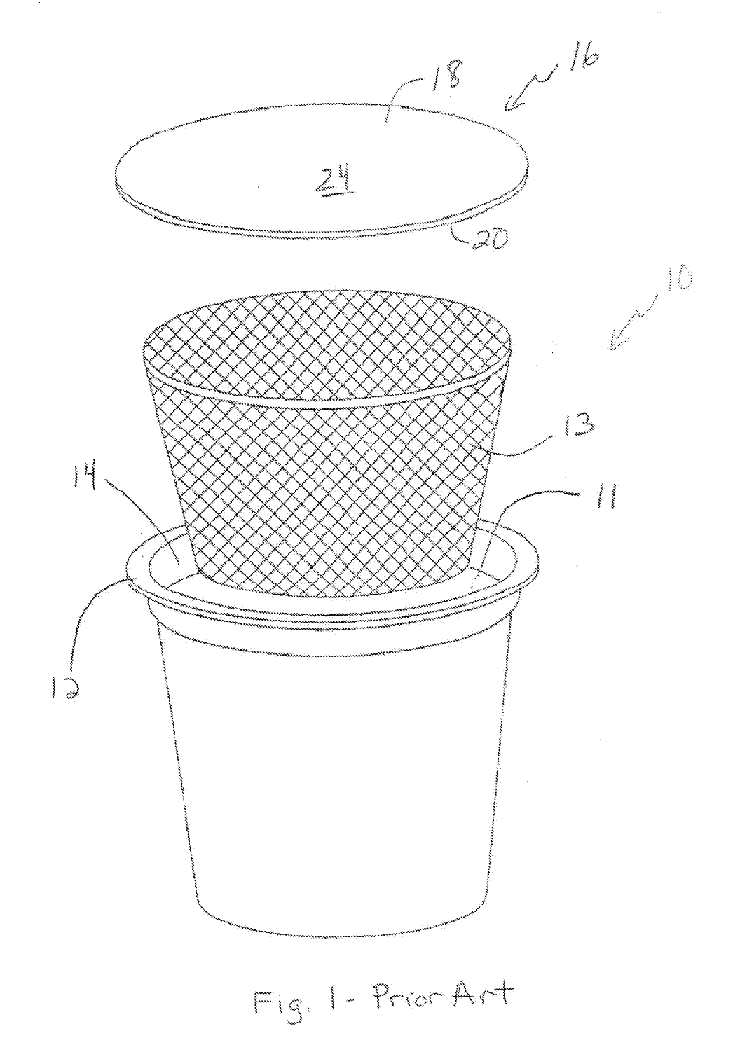

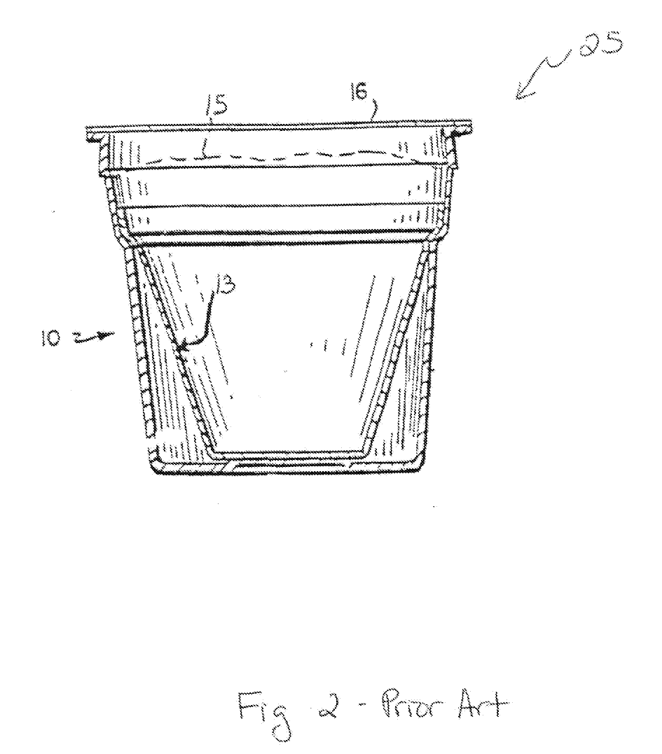

Referring now to the FIGS. 1-2, the product, for example a food or beverage product, is first packaged as needed or as typical inside of a container 10. In the instance of a single-serve coffee cartridge, container or cup 10, includes a reservoir 11 that includes a filter 13 and is filled with a beverage base, such as ground coffee 15 (FIG. 2). Lid 16 is then placed on top of the cup 10, over the opening 14, and is sealed to the cup 10 by any process, now known or developed in the future, thus covering or closing the top opening 14. One non-limiting example is induction sealing, or heat sealing, which is well known in the art and described herein above. Sealing can be completed any number of times in a number of different ways to the satisfaction of the product owner, or according to the needs of the product in order to ensure that the product is shelf stable and remains fresh. For instance, a plastic lid can be placed on the package/container, then a foil lid, then a plastic lid again to allow for another foil lid to be placed on top. Conversely, the plastic lid can be fixed to the container in a recessed manner, which will allow the foil to attach to the edges of the plastic cup. Similarly, a foil lid can be attached to the container, then a plastic (or some other substrate) lid can be attached, to allow for another foil lid to be attached. After sealing the foodstuffs within the container, the sealed container 25 can either go directly to the printing process, or it can be stored at room temperature or in another environment for later processing.

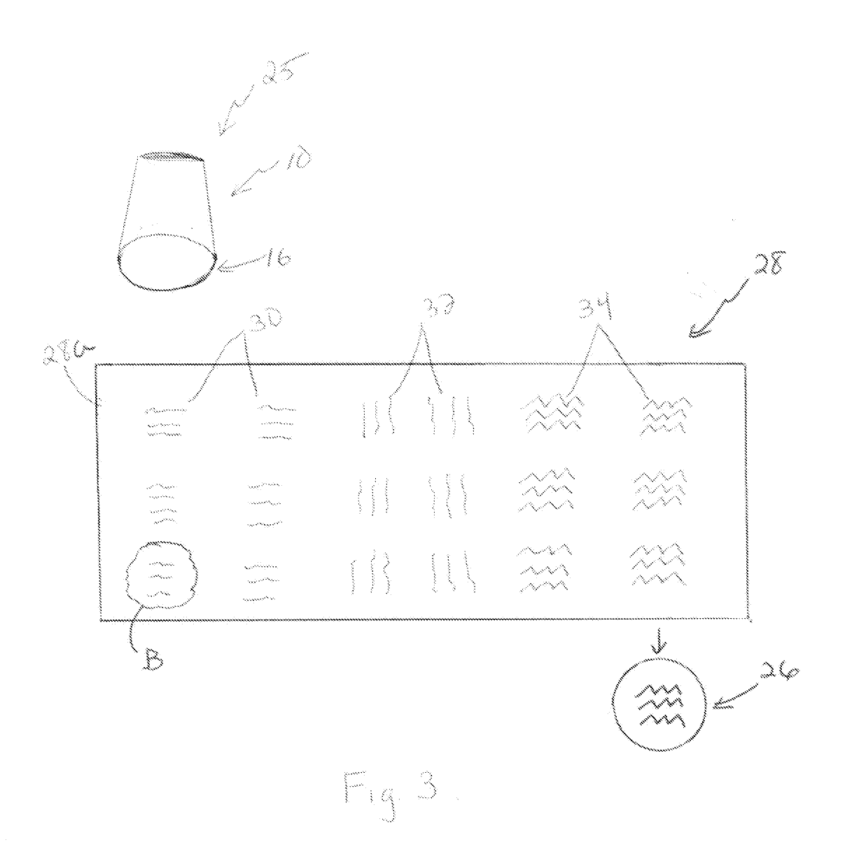

Referring now to FIG. 3, at a time determined by the user, the sealed container enters the printing process, where an additional and imprinted lid, cover, top or layer is applied. In the present example, the imprinted cover 26 is formed of a film or substrate 28 that is printed according to any of a variety of known printing processes in which a design, colorization, or other pattern is placed on the substrate. The substrate 28 may be made of any suitable material, including for example, in the present exemplary embodiment, a thin plastic polymer film, or any other substrate which can be printed with indicia and secured to the lid 16 of the container, and may be opaque, translucent or transparent to allow the design, content, or colors to be seen on the substrate below it. Alternatively, the substrate may be a bottom layer of polymer fully covered by a top layer of aluminum foil or the substrate can simply be a layer of aluminum foil with no underlying polymer film that is adhesively attached to the sealed lid 16. In the case of aluminum foil, the foil can be printed with indicia as desired, or the indicia may be cut into or through the substrate to produce a translucent experience for the customer, whether to see the actual product, or to see colors or designs that will be made visible via the underlying substrates, as known in the art. Alternatively, the substrate can be embossed with the indicia, or the indicia may be otherwise formed on the imprintable layer of the substrate.

The substrate 28 may be in the form of a sheet of one or more layers 28a of material that is run through the printing process and thereafter punched, blanked out or cut to a shape and size that is appropriately shaped to match the sealed lid 16. In the present embodiment, the imprintable substrate 28 includes at least a first, imprintable layer 28a that may be imprinted with multiple orders, i.e. having different designs or indicia 30, 32 and 34 created thereon, and thereafter formed into separate covers 26. When multiple orders are created, the covers 26 within each grouping 30, 32 and 34 may have the same indicia, but different indicia will generally be on the covers between the groupings. The covers, 26 if imprinted, may be cut within the bleed area “B” of each imprinted cover of the substrate. The substrate that has been cut into the imprinted cover 26 is then attached to the top surface of the sealed lid 16, which was previously sealed to the container 10 as described above. Attachment of the substrate 28 may be done by adhesive, induction heating, or in other manners known in the art. Alternatively, the substrate 28 may be pre-cut to the appropriate shape, attached to the sealed lid and thereafter printed. In either instance, the completed, sealed labeled container is ready to be shipped to a purchaser, or distributed to a consumer or other end user.

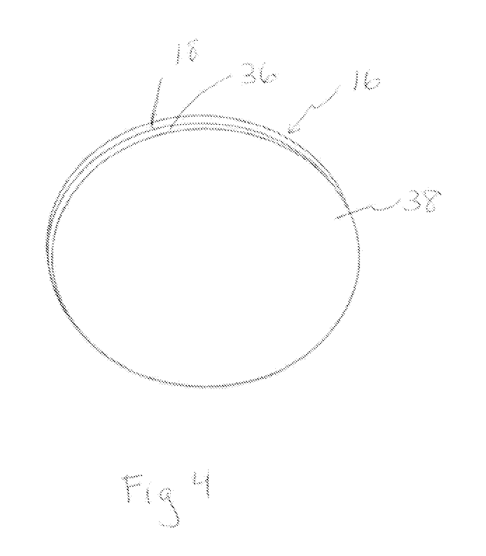

In an alternate embodiment as shown in FIG. 4, a top adhesive layer 36 is attached to the first layer 18 of the lid 16 such that it substantially covers the first layer 18 of the lid 16. The adhesive layer 36 is then covered by a removable backing 38. After printing the substrate 28, which can be made of any material that is capable of sticking to the adhesive layer 36 (for example, plain paper), the backing 38 is removed and the printed substrate 28 is properly sized and attached to the adhesive layer 36. This embodiment may be particularly suited for at-home or do-it-yourself customization.

An advantage of the invention is that the filling and sealing the foodstuffs in the containers done as a separate step as part of the packaging process, and can be separate from the labeling process. In this manner, packaging and labeling can be performed in separate locations and/or at different times. The pre-filled, sealed containers can be inventoried and stored for later distribution. Thereafter, as needed, the inventoried containers may be branded or otherwise custom imprinted on-demand for a much quicker delivery experience for customers. The particular labeling can be customized to a consumer's printing specifications as is known in the printing art, and the substrate can be printed and then applied to an appropriate quantity of inventoried containers, as needed. This allows small quantities of custom printed containers to be sold at prices that are similar to those for larger quantities, but much more quickly and with the same high quality standards.

It will be understood by those skilled in the art that various changes in form and details may be made herein without departing from the spirit and scope of the invention as defined by the appended claims. Those skilled in the art will appreciate that the conception, upon which this disclosure is based, may readily be utilized as a basis for designing other products. Therefore, the claims are not to be limited to the specific examples depicted herein. For example, the materials disclosed herein may be readily changed, as may the dimensions and geometric configurations. The container may be a different configuration other than those disclosed herein, provided that it is capable of holding a product to be sealed. Likewise, while the product to be sealed is contemplated to be foodstuffs, the invention is applicable to other goods that are packaged in manners described herein in order to retain freshness. As will be appreciated, various modifications and rearrangements of the parts may be made without departing from the spirit and scope of the underlying inventive concept and that the same is not limited to the particular forms herein shown and described except insofar as indicated by the scope of the appended claims.

Further, the purpose of the Abstract is to enable the U.S. Patent and Trademark Office, and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the claims of the application nor is intended to be limiting on the claims in any way.

What is claimed is:

1. A method of creating a labeled packaged product, comprising:
providing a container including a bottom, a top opening, and a reservoir constructed and arranged to hold the product;
providing a lid sized to cover the top opening;
sealing the lid to the container such that the lid closes the top opening of the container;
providing a substrate having at least one layer;
creating indicia on the imprintable layer of the substrate;
creating a cover from the substrate including at least a portion of the indicia; and
securing the cover to the lid, such that the indicia is visible to a consumer, to create the labeled packaged product.

2. The method of claim 1, wherein the indicia is printed on the imprintable layer of the substrate.

3. The method of claim 1, wherein the indicia is embossed on the imprintable layer of the substrate.

4. The method of claim 1, wherein the indicia is cut through the imprintable layer of the substrate.

5. The method of claim 1, wherein the product is foodstuffs and the sealing provides an oxygen resistant barrier.

6. The method of claim 5, wherein the foodstuffs is a beverage base.

7. The method of claim 6, wherein the beverage base is ground coffee.

8. The method of claim 7, further comprising providing a filter within the reservoir.

9. The method of claim 2, further comprising the step of cutting the cover from the imprinted substrate within a bleed area of the substrate.

10. The method of claim 1, wherein the imprintable layer of the substrate comprises metal foil.

11. The method of claim 1, wherein the substrate comprises a sheet and the step of creating visible indicia includes creating two or more types of indicia on the sheet.

12. The method of claim 11, wherein creating the cover includes creating at least a first cover and at least a second cover, the first and second cover each having different indicia.

13. The method of claim 1, wherein the cover is secured to the lid by induction heating.

14. The method of clam 1, wherein the cover is secured to the lid by adhesive.

15. The method of claim 14, wherein the adhesive is provided on a first layer of the lid and is covered by a removable backing to secure the cover.
